(19) United States
(12) Patent Application Publication
(10) Pub. No.: US 2026/0161185 A1
(43) Pub. Date: Jun. 11, 2026

(54) METHOD AND DEVICE FOR SHARED CONTROL OF AN END EFFECTOR FOR PERFORMING A TASK BY MEANS OF A CONTROL DEVICE

(71) Applicant: Deutsches Zentrum für Luft- und Raumfahrt e.V., Bonn (DE)

(72) Inventors: Gabriel QUERE, Gilching (DE); Jörn VOGEL, Munchen (DE); Annette HAGENGRUBER, Munchen (DE)

(73) Assignee: Deutsches Zentrum für Luft- und Raumfahrt e.V., Bonn (DE)

(21) Appl. No.: 19/409,905

(22) Filed: Dec. 5, 2025

(30) Foreign Application Priority Data
Dec. 5, 2024 (DE) 10 2024 136 331.2

(51) Int. Cl. G05D 1/82; B25J 9/16

(52) U.S. Cl. CPC G05D 1/82; B25J 9/1602

(57) ABSTRACT

A method for shared control of an end effector to perform a task includes using a control device to control the end effector. The task comprises at least two sub-steps to be performed sequentially, each sub-step having predetermined constraints and being responsive to user commands. The control device controls the end effector based on the predetermined constraints and user commands for each sub-step. When transitioning from a current sub-step to a next sub-step, the control device determines whether the end effector fulfills all constraints required for the transition to the next sub-step. If not all required constraints are fulfilled, the control device blocks the transition to the next sub-step. If all required constraints are fulfilled, the control device transitions to the next sub-step. During blocking, the end effector may continue to be controlled in a restricted manner, with only those user commands that would affect the transition being restricted.

### CROSS-REFERENCE TO RELATED APPLICATIONS

This application claims priority under 35 U.S.C. § 119 to German Patent Application No. DE 10 2024 136 331.2, filed on Dec. 5, 2024, the entire disclosure of which is incorporated herein by reference.

### BACKGROUND OF THE DISCLOSURE

### 1. Field of the Disclosure

The present disclosure relates to a method and a device for shared control of an end effector for performing a task by means of a control device.

### 2. Description of Related Art

Shared control is a concept in robotics in which the control of a system is shared between a user and an assistance system. For example, the user decides which task is to be carried out, while the user and the assistance system jointly control the system's status variables in order to successfully complete the task.

A typical example of such a system is a robot arm with an end effector that enables people with motor impairments to carry out tasks independently. The user specifies a general direction of movement for the end effector, and the assistance system supports the precise positioning and alignment of the end effector. In this way, the end effector can be precisely aligned to perform the task.

Currently, however, shared control usually takes place in an open-loop control. This is a problem because the system cannot react to errors, inappropriate user input, or unexpected changes in the environment.

In addition, a task in a system with shared control is usually divided into a sequence of sub-steps that are performed one after the other. This means that in each sub-step, a support action assigned to this sub-step is performed
and the next sub-step can only take place once this action has been completed. In the case of the robot arm mentioned above, this means that in each sub-step, the end effector not only performs the support action assigned thereto, but must also be brought into the correct position and orientation, depending on the respective workspace conditions.

Currently, however, the speed of movement of the end effector is often not taken into account in shared control. As a result, it cannot be guaranteed that the end effector is already correctly positioned and aligned after completing an action assigned to a sub-step and when transitioning to the next sub-step. As a result, the support actions can take place differently when the same task is performed repeatedly due to different user input speeds, which can lead to reduced performance or even failure of the task.

### SUMMARY OF THE DISCLOSURE

The object of the disclosure is to have a task performed as error-free as possible by a system with shared control.

The object is solved by the features of the independent patent claims. Advantageous configurations are stated in the dependent patent claims. It is noted that the features specified in the patent claims can be combined individually with one another and/or with subject matters of the general description, whereby further embodiment variants of the disclosure are shown.

A method for the shared control of an end effector for performing a task by means of a control device contributes to this, wherein the task is divided into at least two sub-steps to be performed one after the other and the end effector is controlled by the control device taking into account constraints and user commands predetermined for the respective sub-steps, and wherein the following is carried out by the control device when changing from the respective sub-step to the respective next sub-step,
checking whether the end effector fulfills all the constraints required for the transition to the next sub-step when transitioning from the current sub-step to the next sub-step, and
blocking the transition if not all constraints required for the transition to the next sub-step are fulfilled, or
changing from the respective sub-step to the respective next sub-step if the required constraints are fulfilled.

The method according to the disclosure is used in particular in shared control, a control concept in which the control of a system—in this case of an end effector—is shared between an automated control device and a human user.

In robotics, an end effector is the last link in a kinematic chain that interacts directly with the environment and performs tasks. A typical example of an end effector is the gripper of a robot arm, which can grip and release objects, for example, to grasp a drawer handle. One possible task would therefore be to open a drawer with the robot arm's gripper.

Unlike conventional control systems, such as manual or fully automatic control, shared control is performed by both the user and the control device. This means that the user can influence the control of the end effector in real time, while the end effector performs certain tasks autonomously. Via a user interface, e.g., a joystick, the user can enter user commands before and while performing a task. The control device processes these user commands by combining the user commands with assistance directives (i.e., blending) and/or mapping the user commands to the movements of the end effector. The processed result is then used to control the end effector accordingly.

It can be provided that the task to be performed is divided into at least two successive sub-steps. For example, the task of opening a drawer can be divided into three sub-steps: moving the gripper into the position of the drawer handle with a predefined orientation, gripping the drawer handle, and opening the drawer. These sub-steps are performed one after the other by the end effector, which means that the next sub-step can only be started after the previous sub-step has been completed. In particular, the user can enter user commands into the control device in each sub-step in order to influence the control of the end effector to perform the respective sub-step.

It can also be provided to specify certain constraints that must be adhered to in each sub-step. These constraints define certain parameter limits for the end effector, in particular, which it must not exceed during execution in order to fulfill its function correctly and safely. For example, the end effector may have to maintain a certain height in one sub-step, while a certain orientation is required in a subsequent sub-step. The specified height and orientation, therefore, represent the respective constraints for the corresponding sub-steps in this example.

In particular, it can be provided that the end effector is controlled by the control device, taking into account the constraints and user commands specified for the respective sub-steps. The control device can combine the user commands entered in real time with its own pre-programmed instructions for each sub-step in compliance with the specified constraints.

As mentioned at the beginning, shared control is currently generally carried out via open-loop control, in which there is no continuous feedback and correction. This can result in the end effector not being able to react to the violation of constraints due to unexpected changes in the working environment and/or inappropriate user input. Such a violation can, in turn, cause the task to fail.

To avoid this, it can be provided to check whether the end effector fulfills all the constraints required for the change when transitioning from one sub-step to the next. This check can be carried out by checking the pose of the end effector, i.e., its position and orientation. If the end effector was brought into the correct position and orientation when transitioning from the current sub-step, the required constraints are considered fulfilled.

If it is determined that all necessary constraints have been fulfilled, transitioning to the next sub-step is initiated. In this case, the execution of the current sub-step ends, the current sub-step is set to the deactivation state, and the execution of the next sub-step begins, wherein this next sub-step changes to the activation state.

If, however, the end effector is not able to fulfill all the necessary constraints when transitioning to the next sub-step, the change is blocked. Blocking the transition means that the execution of the next sub-step cannot be started, and it remains in the deactivation state until the required constraints in the current sub-step have been fulfilled. However, blocking the transition does not mean that the input of user commands is interrupted; on the contrary, the user can continue to enter commands to the control device during this blocking phase.

In addition, it can be provided that the current sub-step remains in the activation state during the blocking phase, so that the end effector continues to be controlled until it fulfills all the constraints required for the current sub-step and can transition to the next sub-step.

The method according to the disclosure ensures compliance with the required constraints in each sub-step and thus enables the end effector to perform the task safely, precisely, and efficiently. The end effector is controlled by both the user and the control device as part of shared control—even in an open control loop without continuous feedback or correction of the actual task execution. Even in the event of an error, the input of user commands does not have to be interrupted, which is particularly advantageous if the end effector is used as part of an assistance device for motor-impaired persons, such as a robot arm or a motorized wheelchair with an integrated robot arm.

It is preferred that the end effector can still be controlled in a restricted manner during the blocking phase, wherein only those user commands that would influence the transition from the current sub-step to the next sub-step are restricted. This has the advantage of avoiding a complete interruption of movement during the blocking phase by still allowing limited control of the end effector based on user input. This embodiment variant ensures that the end effector can react flexibly to user inputs at critical moments without losing efficiency due to a waiting time. This ensures that the end effector is only controlled within the working area of the current sub-step until the required constraints are fulfilled.

It is preferred that the fulfillment of the constraints is checked during this test phase by checking the pose of the end effector, wherein the required constraints are considered fulfilled if the end effector has been brought into the correct position and orientation during the transition from the current sub-step to the next sub-step.

It is preferred that the following be carried out during this test phase:
a) detecting a target pose of the end effector provided by the control device based on user commands,
b) detecting intermediate poses of the end effector provided by the control device by tracking the target pose, wherein the end effector was guided along the movement trajectory formed by these intermediate poses,
c) comparing the target pose with the last intermediate pose provided, and
d) determining that the required constraints are considered fulfilled if the difference between the target pose and the intermediate pose is less than a specified difference.

In robotics, the pose refers to the position and orientation of an object—in this case, the end effector—in space. The pose of the end effector includes both the position (e.g., x, y, and z coordinates in three-dimensional space) and the orientation (e.g., rotations around the x, y, and z axes).

According to a), the target pose of the end effector is provided by the control device based on the user commands. The user can use a user interface such as a joystick for this purpose. Joysticks with two degrees of freedom allow movements in two directions (e.g., forwards/backwards and left/right), while joysticks with three degrees of freedom also allow movements along a third axis (e.g., up/down). These movements are entered as user commands into the control unit, which can then provide the target pose with six degrees of freedom—three for translation (movement along the x, y, and z axes) and three for rotation (rotation around the x, y, and z axes). These six degrees of freedom allow the end effector to assume any position and orientation in three-dimensional space.

According to b), the intermediate pose is provided by the control device based on the target pose. In particular, the intermediate pose can be generated by a dynamic system integrated in the control device, such as an interpolator, in that this system follows the target pose and, while doing so, generates intermediate poses. These intermediate poses are on the way to the target pose and allow the end effector to move gradually towards the target pose. The end effector then follows the movement trajectory formed by the intermediate poses instead of moving directly to the target pose.

According to c), the target pose is compared with the intermediate pose. In particular, the target pose is compared with the last intermediate pose provided.

According to d), the required constraints are considered fulfilled if the difference between the target pose and the intermediate pose is less than a specified difference. This difference indicates how far away the intermediate pose is from the target pose, both in terms of position and orientation. Preferably, this difference is calculated in the special Euclidean group SE (3), taking into account both the linear distance (between the positions) and the angular distance (between the orientations). The required constraints are only considered fulfilled if this difference is less than the specified difference.

It is preferred that during this blocking phase, the end effector continues to be controlled in a limited manner by guiding the end effector to a newly generated target pose based on the user commands entered during the blocking phase, provided that these user commands would not affect the transition from the current sub-step to the next sub-step.

It is preferred that during this blocking phase, the end effector continues to be controlled in a restricted manner in that the last intermediate pose provided is covered along the movement trajectory in the working area of the current sub-step and, starting from this covered intermediate pose, further intermediate poses are provided while tracking the target pose, so that the end effector is guided along the new movement trajectory formed by these new intermediate poses.

It is preferred that the control device comprises a shared control template and that the task is modeled in the form of a state machine in the shared control template. It is particularly preferred that the target pose be provided by the shared control template.

A shared control template is a framework that can model the sub-steps of a task using an FSM. In the FSM, an input mapping (IM) and active constraints (ACs) can be defined for each sub-step. The input mapping assigns the low-dimensional user command inputs (e.g., by a joystick with three degrees of freedom) to the task-specific displacements of the high-dimensional target pose (e.g., with six degrees of freedom) of the end effector. The active constraints set additional limits for the end effector's target pose in order to support the successful execution of the task. In particular, it can be provided that the shared control template provides the target pose as output, which depends on the user commands and takes into account the constraints in the various sub-steps of the task to be executed.

It is preferred that the control device comprises an interpolator and that the intermediate positions are provided by the interpolator.

An interpolator is a dynamic tool that uses interpolation algorithms to calculate and output intermediate poses in order to create a smooth path between two poses that the end effector can follow. The target pose output by the shared control template can be entered into the interpolator so that it continuously follows the target pose and generates intermediate poses step by step that define the path to the target pose.

It is preferable that the constraints are specified in the form of fixed values, function values, and/or manifolds.

For fixed values, it can be provided that a degree of freedom (DoF) of the end effector is fixed to a certain value, e.g., a fixed height, so that the end effector can only move at this height. For function values, on the other hand, various functions such as inequalities, polynomials, dot products, or user-defined functions can be used. These functions use inputs such as distances or transformations to dynamically control the movement of the end effector. For example, a function can adjust the angle of the end effector based on the distance to a target point. With the help of manifolds, a certain range of motion can be defined in high-dimensional space, which restricts the end effector to a flexible but limited range.

The disclosure further comprises a robot system for the shared control of an end effector of a robot for performing a task, wherein the task is divided into at least two sub-steps to be performed one after the other, comprising at least one control device, wherein the control device is configured so that the end effector is controlled by the control device taking into account constraints and user commands predetermined for the respective sub-steps, and wherein the control device is configured to perform the following when changing from the respective sub-step to the respective next sub-step:
checking whether the end effector fulfills all the spatial constraints required for the transition to the next sub-step when transitioning from the current sub-step to the next sub-step,
blocking the transition if not all spatial constraints required for the transition to the next sub-step are fulfilled, and
   changing from the respective sub-step to the respective next sub-step if the required spatial constraints are fulfilled.

It is preferred that the control device is configured so that during this blocking phase, the end effector can still be controlled by the control device to a limited extent, wherein only those user commands that would influence the transition from the current sub-step to the next sub-step are restricted.

It is preferred that the control device comprises a shared control template that is configured to model the task in the form of a state machine and provide a target pose based on the user commands.

It is preferred that the control device comprises an interpolator that is configured to provide intermediate poses by tracking the target pose.

It is preferred that the control device is configured so that the end effector is controlled, taking into account constraints in the form of fixed values, functional values, and/or manifolds.

### BRIEF DESCRIPTION OF THE DRAWINGS

The solution presented here, and its technical environment, are explained in more detail below using the figures. It should be noted that the disclosure is not intended to be limited by the exemplary embodiments shown. In particular, unless explicitly shown otherwise, it is also possible to extract partial aspects of the facts explained in the figures and combine them with other components and/or findings from other figures and/or the present description. The following is shown schematically and by way of example:

FIG. 1 shows a method according to the disclosure for shared control of an end effector,

FIG. 2 shows a known method according to the disclosure for shared control of an end effector,

FIG. 3 shows a problem scenario in the method according to FIG. 2,

FIG. 4 shows a comparison of problem scenarios in the method according to FIG. 2 at different user command input speeds,

FIG. 5 shows an embodiment variant for the limited control during the blocking phase, and

FIG. 6 shows a further embodiment variant for the limited control during the blocking phase.

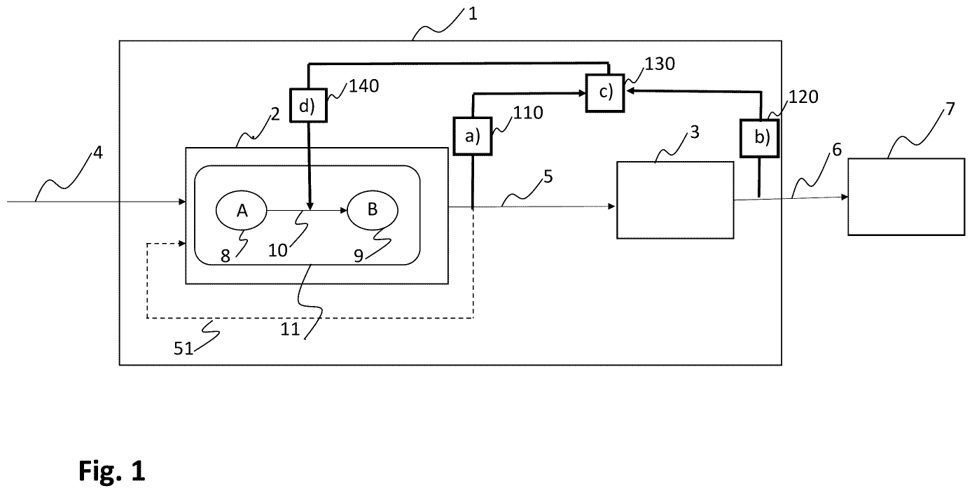

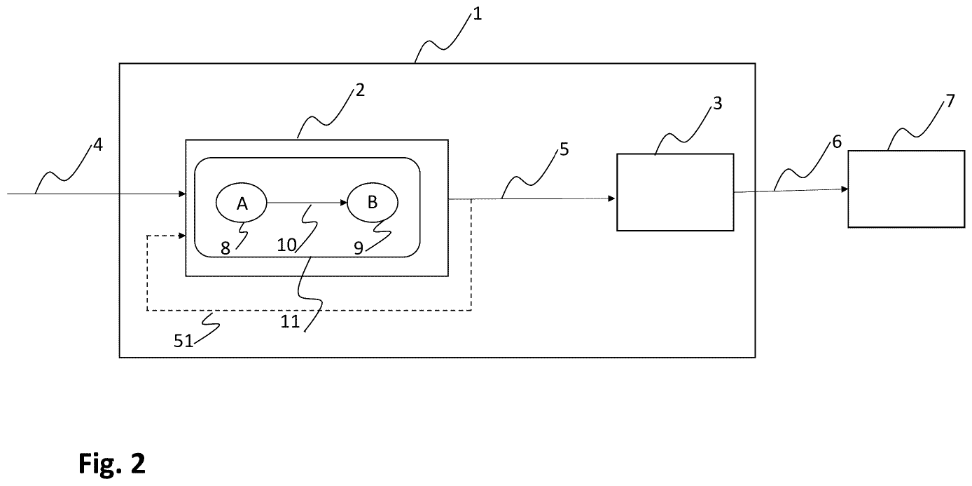

FIG. 1 shows a method according to the disclosure for shared control of an end effector, while FIG. 2 shows a known method for shared control of an end effector.

### DETAILED DESCRIPTION OF THE DISCLOSURE

In FIG. 1 and FIG. 2, it can be seen that the method according to the disclosure additionally comprises the method steps a), b), c), and d) compared to the known method. In order to illustrate the differences between the method according to the disclosure and the known method and the resulting positive technical effect more clearly, FIGS. 1 and 2 are compared here. First, FIG. 2 describes the known method in order to illustrate the problem that arises. The method according to the disclosure is then explained with reference to FIG. 1 in order to illustrate how the method steps a), b), c), and d) can contribute to solving the problem.

FIG. 2 shows an end effector 7 that is controlled by a user (not illustrated) and a control device 1 in a shared manner. The control device 1 comprises a shared control template 2 and an interpolator 3. The shared control template 2 provides a target pose 5 of the end effector 7 based on user commands 4, while the interpolator 3 generates intermediate poses 6 of the end effector 7 by tracking the target pose 5 provided by the shared control template 2, so that the end effector 7 is controlled based on the intermediate poses 6.

FIG. 2 also shows that a task to be performed with the end effector 7 is divided into a sub-step _A 8 and a sub-step _B 9, which are to be performed one after the other. Both in sub-step _A 8 and in sub-step _B 9, the end effector 7 is to be moved in compliance with the constraints assigned to the respective sub-step 8, 9 (e.g. compliance with a predetermined orientation and/or height of the end effector) on the one hand and controlled to perform an action assigned to the respective sub-step 8, 9 on the other hand. The task with the sub-steps _A 8 and _B 9 is modeled by a state machine 11 in the shared control template 2.

FIG. 2 further shows that the target pose 5 provided by the shared control template 2 is fed back into the template (see dashed line), so that the target pose 5 is provided in a cumulative manner based on the last target pose 51 and the user commands 4.

As already mentioned, the intermediate poses are provided on the basis of the target pose, and the end effector is controlled on the basis of the intermediate poses. Therefore, during the sub-step change 10, the last intermediate pose 6 provided should be as close as possible to the target pose 5.

However, the following problems can occur with the known method according to FIG. 2: The user usually enters the user commands 4 into the shared control template 2 via a user interface, such as a joystick (not illustrated). If the user enters the commands 4 too quickly, the target pose 5 is also provided correspondingly quickly. This can lead to the difference between the last intermediate pose 6 provided and the target pose 5 being too large during the sub-step change 10. It can happen that the intermediate pose cannot follow the target pose, which means that the required constraints are not yet fulfilled, especially with sub-step changes.

With the method according to the disclosure and according to FIG. 1, the problems mentioned above can be avoided.

FIG. 1 shows that, in addition to the steps of the known method according to FIG. 2, method steps a), b), c), and d) are carried out during the sub-step change 10 from sub-step _A 8 to sub-step _B 9. The illustrated steps a), b), c), and d) with blocks 110, 120, 130, and 140 serve as examples. In block 110, the target pose 5 of the end effector 7 is detected at this point in time. In block 120, an intermediate pose 6 of the end effector 7 is also detected at this point in time. In block 130, the detected target pose 5 is compared with the detected intermediate pose 6. In block 140, the sub-step change 10 only takes place when the detected intermediate pose reaches the detected target pose.

The method steps a) to d) of the method according to the disclosure can ensure that the end effector 7 is brought into the correct position and orientation at the time of the sub-step change 10 in accordance with the spatial constraints of the respective sub-steps 8 and 9, without user commands being blocked. It also ensures that the entire task can be performed without any loss of performance, even if the control loop is an open-loop control.

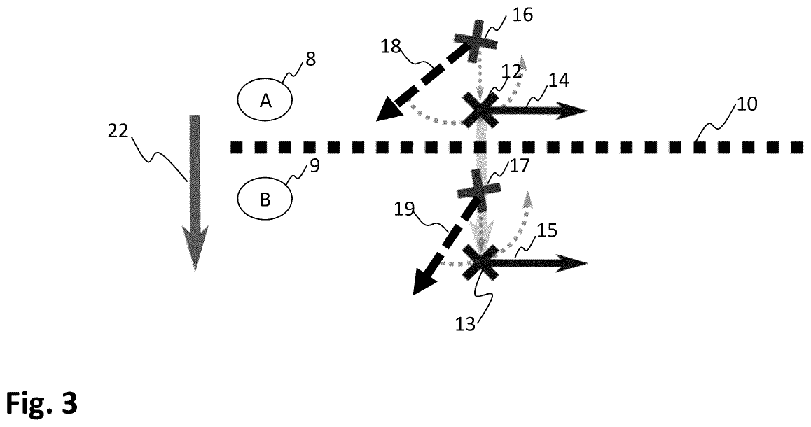

FIG. 3 shows a typical problem scenario that can occur in the method shown in FIG. 2. In FIG. 3, the crosses 12, 13, 16, 17 represent the positions of the end effector, and the arrows 14, 15, 18, 19 represent the orientations of the end effector. The end effector should be guided according to the initial direction of movement 22 entered by the user.

FIG. 3 shows that there is a translational shift between the target position _t 12 of the end effector in sub-step _A 8 and the target position_t+1 13 of the end effector in sub-step _B 9. According to the method of FIG. 2, the target position _t 12 is provided based on the user commands from, for example, the shared control template at time t, while the target position_t+1 13 is provided based on the user commands from, for example, the shared control template at time t+1.

FIG. 3 also shows that both the target orientation _t 14 remains horizontal in sub-step _A 8 and the target orientation _t+1 15 remains horizontal in sub-step _B 9. This can mean that the constraints for sub-step _A 8 are specified so that the orientation of the end effector must be set horizontally before sub-step _B 9 is performed.

In FIG. 3 it can be seen in particular that between the intermediate position _t 16 of the end effector in sub-step _A 8 and the intermediate position_t+1 17 of the end effector in sub-step _B 9 there is also a translational displacement, while between the intermediate orientation _t 18 of the end effector in sub-step _A 8 and the intermediate orientation_t+1 19 of the end effector in sub-step _B 9 there is only a slight rotation.

According to the method of FIG. 2, the intermediate position _t 16 and the intermediate orientation _t 18 (i.e. the intermediate pose at time t) are provided by the interpolator at time t based on the target position _t 12 and the target orientation _t 14 (i.e. the target pose at time t), and the end effector is thus controlled at time t based on the intermediate position _t 16 and the intermediate orientation _t 18.

Accordingly, the intermediate position _t+1 17 and the intermediate orientation _t+1 19 are also provided by the interpolator at time t+1 based on the target position _t+1 13 and the target orientation _t+1 15, so that the end effector is controlled based on the intermediate position _t+1 17 and the intermediate orientation _t+1 19 at time t+1.

As mentioned above, the target position _t 12 and the target position _t+1 13 are provided based on the user commands at time t and time t+1. This can lead to the problem scenario that in sub-step _B 9, the intermediate orientation _t+1 19 is not yet set horizontally like the target orientation _t+1 15 if the user enters the user commands too quickly. As a result, the constraints defined for sub-step _A 8 are violated. Such violations of constraints can lead to a reduction in performance or failure of the entire task.

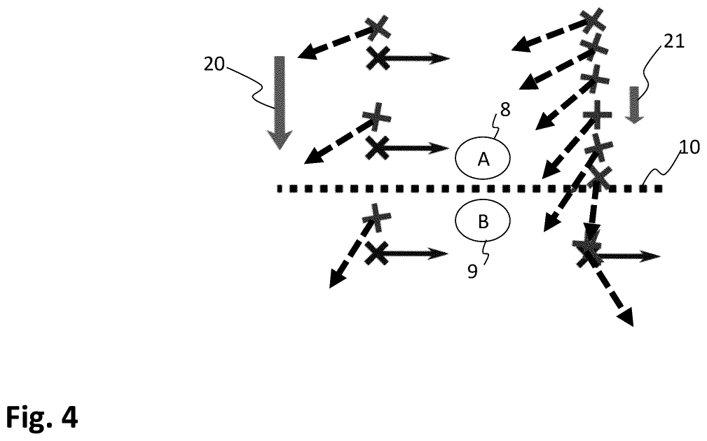

FIG. 4 schematically and exemplarily shows a comparison of problem scenarios in the method according to FIG. 2 at different user command input speeds. FIG. 4 on the left shows the case of a high user command input speed 20, while FIG. 4 on the right shows the case of a relatively low user command input speed 21.

In FIG. 4, the constraints for sub-step _A 8 are defined as in FIG. 3. This means that the intermediate orientation (dashed arrows) must be set horizontally before activating sub-step _B 9.

In comparison with FIG. 3, FIG. 4 shows more clearly how the speed of user command input influences compliance with these constraints.

In the case of high user command input speed 20, the user enters the user commands into the shared control template faster than in the case of low user command input speed 21. Therefore, the end effector in case 20 has less time to adjust its orientation horizontally than in case 21 before sub-step _B 9 is activated. This means that the faster the user commands are entered, the greater the deviation from compliance with the spatial constraints. FIG. 4 also shows that in sub-step _B 9 the deviation between the horizontally set target orientation (solid arrows) and the intermediate orientation (dashed arrows) that has not yet been set horizontally is greater in case 20 than in case 21.

FIG. 4 thus illustrates the cause of non-compliance with the constraints, namely the excessive speed of user command input by the user.

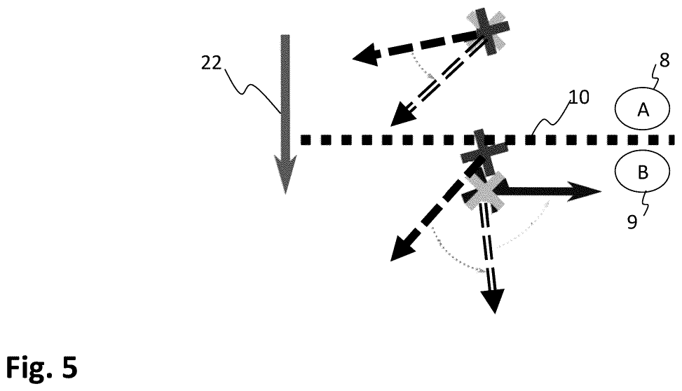

FIG. 5 shows an embodiment variant with which the non-compliance with constraints shown in FIG. 3 and FIG. 4 can be avoided.

FIG. 5 initially shows the same problem scenario as in FIG. 3 and FIG. 4, i.e., at the time of the sub-step change 10 from sub-step _A 8 to sub-step _B 9, the intermediate orientation (dashed arrows) has not yet reached the target orientation (solid arrows). This means that the required constraints have not yet been fulfilled for sub-step change 10.

To ensure that the required constraints are fulfilled during the sub-step change 10, it is checked whether the end effector fulfills all the constraints required for the transition to the next sub-step, i.e., in the case of FIG. 5, whether the intermediate orientation (dashed arrows) has reached the target orientation (solid arrows). If this is not the case, the sub-step change 10 is blocked.

FIG. 5 also shows a preferred embodiment variant in which the end effector is controlled in a restricted manner during the blocking phase until the required constraints are fulfilled.

FIG. 5 shows that during the blocking phase, the currently detected intermediate pose in sub-step _B 9 (dashed arrows with corresponding cross in sub-step _B) is returned along the movement trajectory of the end effector in the working area of sub-step _A 8 (double-dashed arrows with corresponding cross in sub-step _A). This allows the interpolator to generate further intermediate poses within the working area of sub-step _A 8, starting from this returned intermediate pose and by following the initial direction of movement 22 entered by the user, until the last newly generated intermediate pose reaches the initial target pose.

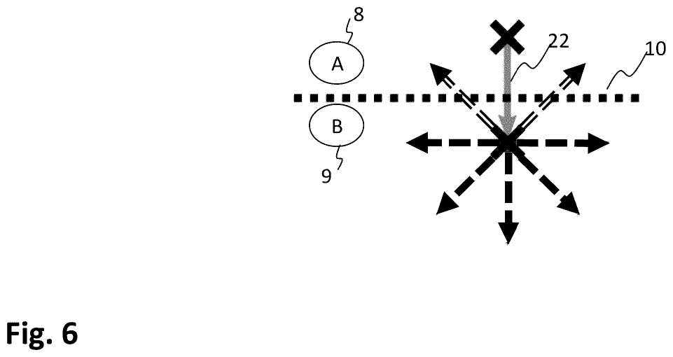

FIG. 6 shows another preferred embodiment variant in which the end effector does not follow an intermediate pose during the blocking phase, but is controlled based on a newly generated target pose candidate until the required constraints are fulfilled. This so-called target pose candidate is generated on the basis of the user commands entered during the blocking phase, e.g., by the shared control template. If additional user commands are entered during the blocking phase, these are not blocked. Instead, at least one further target pose is provided as a target pose candidate based on these commands, also by the shared control template. The system then checks whether this target position candidate immediately triggers the sub-step change 10.

FIG. 6 shows that, in addition to the initial direction of movement 22 (solid arrows), a total of seven further directions of movement are entered by the user in the form of user commands during the blocking phase: five dashed arrows and two double-dashed arrows. The directions of movement shown by the five dashed arrows could lead directly to the sub-step change 10 and must therefore not be used. In contrast, the two double-dashed arrows indicate directions of movement that allow for return to the working area of sub-step A. This means that the sub-step change 10 does not take place, so that the effector can be controlled along these two directions of movement until the required constraints are fulfilled.

### LIST OF REFERENCE NUMERALS

1 control device
2 shared control template
3 interpolator
4 user commands
5 target pose _t
51 target pose _t−1
6 intermediate pose
7 end effector
8 sub-step _A
9 sub-step _B
10 sub-step change
11 state machine
12 target position _t
13 target position _t+1
14 target orientation _t
15 target orientation _t+1
16 intermediate position _t
17 intermediate position _t+1
18 intermediate orientation _t
19 intermediate orientation _t+1
20 high user command input speed
21 low user command input speed
22 initial direction of movement
110 method step a)
120 method step b)
130 method step c)
140 method step d)

What is claimed is:

1. A method for shared control of an end effector to perform a task using a control device, wherein the task comprises at least two sub-steps to be performed sequentially, each sub-step having predetermined constraints and being responsive to user commands, the method comprising:
controlling the end effector with the control device based on the predetermined constraints and the user commands for each sub-step; and
when transitioning from a current sub-step to a next sub-step:
determining whether the end effector fulfills all constraints required for the transition to the next sub-step;
blocking the transition to the next sub-step if not all constraints required for the transition are fulfilled; and
transitioning to the next sub-step if all constraints required for the transition are fulfilled.

2. The method according to claim 1,
wherein while blocking the transition to the next sub-step, the end effector continues to be controlled in a restricted manner, and
wherein only those user commands that would influence the transition from the current sub-step to the next sub-step are restricted.

3. The method according to claim 2,
wherein determining whether the end effector fulfills all constraints required for the transition to the next sub-step comprises a test phase in which a pose of the end effector is checked, and
wherein the constraints are considered fulfilled if the end effector has a correct position and orientation for transitioning from the current sub-step to the next sub-step.

4. The method according to claim 3, wherein during the test phase the following is performed:
detecting a target pose of the end effector provided by the control device based on the user commands;
detecting intermediate poses of the end effector provided by the control device by tracking the target pose,
wherein the end effector is guided along a movement trajectory formed by the intermediate poses;
comparing the target pose with a last one of the intermediate poses; and
determining that the constraints are considered fulfilled if a difference between the target pose and the last one of the intermediate poses is less than a specified difference.

5. The method according to claim 4, wherein while blocking the transition to the next sub-step, the end effector continues to be controlled in a limited manner by guiding the end effector to a newly generated target pose based on user commands entered while blocking the transition, provided that the user commands would not affect the transition from the current sub-step to the next sub-step.

6. The method according to claim 5, wherein while blocking the transition to the next sub-step, the end effector continues to be controlled in a restricted manner so that:
the last intermediate pose provided is returned to along the movement trajectory within a working area of the current sub-step; and
starting from the last intermediate pose, further intermediate poses are provided while tracking the newly generated target pose, so that the end effector is guided along a new movement trajectory formed by the further intermediate poses.

7. The method according to claim 1,
wherein the control device comprises a shared control template, and
wherein the task is modeled as a state machine in the shared control template.

8. The method according to claim 4, wherein the target pose is provided by a shared control template of the control device.

9. The method according to claim 8,
wherein the control device comprises an interpolator, and
wherein the interpolator provides the intermediate poses.

10. The method according to claim 1, wherein the constraints are selected from the group consisting of: fixed values, function values, and manifolds.

11. A robot system for shared control of an end effector of a robot to perform a task, wherein the task comprises at least two sub-steps to be performed sequentially, each sub-step having predetermined constraints and being responsive to user commands, the robot system comprising:
a control device configured to: control the end effector based on the predetermined constraints and the user commands for each sub-step; and
when transitioning from a current sub-step to a next sub-step:
determine whether the end effector fulfills all constraints required for the transition to the next sub-step;
block the transition to the next sub-step if not all constraints required for the transition are fulfilled; and
transition to the next sub-step if all constraints required for the transition are fulfilled.

12. The robot system according to claim 11,
wherein the control device is further configured to, while blocking the transition to the next sub-step, continue to control the end effector in a restricted manner, and
wherein only those user commands that would affect the transition from the current sub-step to the next sub-step are restricted.

13. The robot system according to claim 11, wherein the control device comprises a shared control template configured to model the task as a state machine and to provide a target pose based on the user commands.

14. The robot system according to claim 13, wherein the control device comprises a shared control template configured to model the task as a state machine and to provide a target pose based on the user commands.

15. The robot system according to claim 11, wherein the constraints are selected from the group consisting of: fixed values, function values, and manifolds.
